(19) United States
(12) Patent Application Publication
(10) Pub. No.: US 2026/0229064 A1
(43) Pub. Date: Aug. 6, 2026

(54) FAKE FINGERPRINT DETECTION DEVICE, OPERATING METHOD THEREOF, AND FINGERPRINTING AUTHENTICATION SYSTEM

(71) Applicant: ELECTRONICS AND TELECOMMUNICATIONS RESEARCH INSTITUTE, Daejeon (KR)

(72) Inventors: Tae Wook KANG, Daejeon (KR); Sung Eun KIM, Daejeon (KR); Hyuk KIM, Daejeon (KR); Mi Jeong PARK, Daejeon (KR); Kyung Jin BYUN, Daejeon (KR); Kwang IL OH, Daejeon (KR); Jae-Jin LEE, Daejeon (KR)

(21) Appl. No.: 19/446,180

(22) Filed: Jan. 12, 2026

(30) Foreign Application Priority Data
Feb. 4, 2025 (KR) 10-2025-0014088

(51) Int. Cl. G06V 40/40; G06V 10/82; G06V 40/12; G06V 40/13

(52) U.S. Cl. CPC G06V 40/45; G06V 10/82; G06V 40/1306; G06V 40/1365; G06V 2201/07

(57) ABSTRACT

A fake fingerprint detection device is provided. The fake fingerprint detection device has a transmitting electrode and a receiving electrode configured to contact an external target object, a signal transmitter configured to output a sequence of pulse signals through the transmitting electrode, and a signal receiver configured to receive a sequence of pulse responses that have passed through the target object through the receiving electrode. The signal receiver may include a signal processor configured to generate a detection metric based on the sequence of pulse responses and determine, based on the detection metric, whether the target object corresponds to a fake fingerprint.

### CROSS-REFERENCE TO RELATED APPLICATION(S)

This application claims priority under 35 U.S.C. § 119 to Korean Patent Application No. 10-2025-0014088 filed on Feb. 4, 2025, in the Korean Intellectual Property Office, the disclosure of which is incorporated by reference herein in its entirety.

### BACKGROUND

### 1. Field of the Invention

The present disclosure relates to a fake fingerprint detection device, an operating method thereof, and a fingerprint authentication system, and more particularly, to a fake fingerprint detection device, an operating method thereof, and a fingerprint authentication system that distinguish between a live fingerprint and a fake fingerprint using a sequence of pulse responses.

### 2. Description of Related Art

With the development of information and communication technologies, the amount of personal information converted into digital data and utilized has been increasing rapidly. Among these technologies, the advancement of Internet of Things (IoT) technology enables access to personal information regardless of time and place.

Traditional authentication methods that rely on media such as ID cards, credit cards, or authorized certificates are vulnerable to identity theft when such media are lost. Accordingly, biometric authentication technologies that utilize the user's unique biological characteristics have recently been adopted to provide safer protection of personal information.

Biometric authentication technologies, which may replace conventional media-based authentication, authenticate users based on physiological or behavioral characteristics. Examples include fingerprint, iris, and facial recognition.

Fingerprint recognition is widely used because of its relatively low development cost, low complexity, and high user convenience. However, fingerprint spoofing—an act of imitating or forging a person's fingerprint using materials such as silicone, rubber, film, gelatin, or synthetic resin—poses serious security risks.

As countermeasures, methods that combine at least two biometric traits or combine biometrics with conventional authentication media have been proposed, but they degrade user convenience.

### SUMMARY

An objective of the present disclosure is to provide a fake fingerprint detection device, an operating method thereof, and a fingerprint authentication system capable of distinguishing between a live fingerprint and a fake fingerprint while maintaining the convenience of fingerprint-based user authentication.

According to an embodiment of the present disclosure, a fake fingerprint detection device may include a transmitting electrode and a receiving electrode that contact an external target object, a signal transmitter that outputs a sequence of pulse signals through the transmitting electrode, and a signal receiver that receives a sequence of pulse responses that have passed through the target object via the receiving electrode. The signal receiver may include a signal processor configured to generate a detection metric based on the sequence of pulse responses and determine whether the target object corresponds to a fake fingerprint based on the detection metric.

According to an embodiment of the present disclosure, an operating method of a fake fingerprint detection device may include outputting a sequence of pulse signals through a transmitting electrode, receiving a sequence of pulse responses that have passed through a target object via a receiving electrode, generating a detection metric based on the sequence of pulse responses, and determining whether the target object corresponds to a fake fingerprint based on the detection metric.

According to an embodiment of the present disclosure, a fingerprint authentication system may include a fake fingerprint detection device configured to output a sequence of pulse signals through a transmitting electrode, receive a sequence of pulse responses that have passed through a target object via a receiving electrode, generate a detection metric based on the sequence of pulse responses, and determine whether the target object is a fake fingerprint based on the detection metric; and a fingerprint sensor configured to, in response to the target object being determined to be a live fingerprint, capture a fingerprint image of the target object, extract minutiae from the fingerprint image, compare the extracted minutiae with pre-registered fingerprint minutiae of a user, and perform user authentication based on the comparison.

### BRIEF DESCRIPTION OF THE DRAWINGS

The above and other objects and features of the present disclosure will become apparent by describing in detail embodiments thereof with reference to the accompanying drawings.

FIG. 1 is a block diagram illustrating a fake fingerprint detection device according to an embodiment of the present disclosure.

FIG. 2 is a diagram illustrating a signal transmitter according to an embodiment of the present disclosure.

FIG. 3 is a diagram illustrating a signal receiver according to an embodiment of the present disclosure.

FIG. 4 is a diagram illustrating a sequence of pulse signals and corresponding pulse responses according to an embodiment of the present disclosure.

FIG. 5 is a diagram illustrating a signal processor according to an embodiment of the present disclosure.

FIGS. 6A to 6C are diagrams illustrating the generation of a delay-time vector for a single pulse response according to an embodiment of the present disclosure.

FIGS. 7A and 7B are exemplary diagrams illustrating detection metrics according to an embodiment of the present disclosure.

FIG. 8 is a diagram for explaining an input to a decision unit according to an embodiment of the present disclosure.

FIG. 9 is a flowchart illustrating an operating method of a fake fingerprint detection device according to an embodiment of the present disclosure.

FIG. 10 is a block diagram illustrating a fingerprint authentication system according to an embodiment of the present disclosure.

FIG. 11 is a flowchart illustrating a fingerprint authentication method according to an embodiment of the present disclosure.

FIG. 12 is a diagram illustrating an example of a computing system that constitutes a signal processor according to an embodiment of the present disclosure.

### DETAILED DESCRIPTION

Hereinafter, embodiments of the present disclosure will be described clearly and in detail so that those skilled in the art to which the present disclosure pertains can easily carry out the disclosure.

Components described with reference to the terms unit, module, block, or suffixes such as “-or” and “-er”, as well as functional blocks shown in the drawings, may be implemented in the form of software, hardware, or a combination thereof. For example, the software may include machine code, firmware, embedded code, or application software. The hardware may include electrical circuits, electronic circuits, processors, computers, integrated circuits, integrated circuit cores, pressure sensors, inertial microelectromechanical systems (MEMS), passive elements, or combinations thereof.

In the present document, each of the phrases “A or B”, “at least one of A and B”, “at least one of A or B”, “A, B, or C”, “at least one of A, B, and C”, and “at least one of A, B, or C” may include any one of the items listed together in the relevant phrase, or any possible combination of all of them.

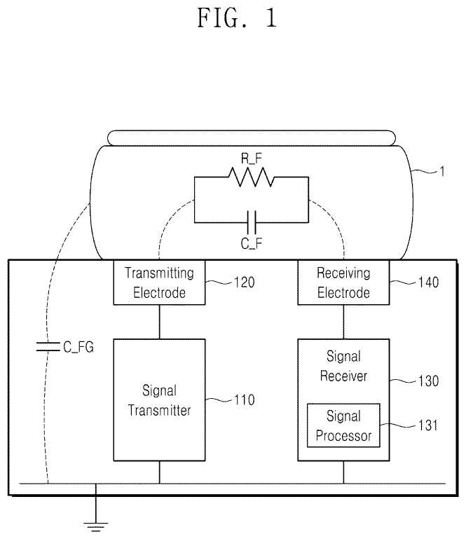

FIG. 1 is a block diagram illustrating a fake fingerprint detection device according to an embodiment of the present disclosure.

Referring to FIG. 1, the fake fingerprint detection device 100 may include a signal transmitter 110, a transmitting electrode 120, a signal receiver 130, and a receiving electrode 140.

The fake fingerprint detection device 100 may determine whether a target object 1 contacting the outside of the device corresponds to a live fingerprint of a user or a fake fingerprint made of silicone, rubber, film, gelatin, synthetic resin, or similar materials.

The transmitting electrode 120 and the receiving electrode 140 may contact the target object 1 located outside the fake fingerprint detection device 100. The target object 1 may form an electrical channel between the transmitting electrode 120 and the receiving electrode 140. The target object 1 may be modeled as having a finger resistance R_F and a finger capacitance C_F. A coupling capacitance C_FG may be formed between the target object 1 and ground.

The signal transmitter 110 may output a sequence of pulse signals through the transmitting electrode 120. The sequence of pulse signals is transmitted to the target object 1. The sequence of pulse signals may pass through the electrical channel formed by the target object 1 and be transmitted to the receiving electrode 140.

The signal receiver 130 may receive a sequence of pulse responses through the receiving electrode 140. The sequence of pulse responses corresponds to distorted response signals generated while the sequence of pulse signals output from the signal transmitter 110 passes through the target object 1. The signal receiver 130 may determine whether the target object 1 corresponds to a fake fingerprint based on the sequence of pulse responses.

The signal receiver 130 may include a signal processor 131. The signal processor 131 may generate a detection metric based on the sequence of pulse responses. The signal processor 131 may determine whether the target object 1 corresponds to a fake fingerprint based on the detection metric. The signal processor 131 may determine whether the target object 1 is a live fingerprint or a fake fingerprint by using characteristic information of a biological channel of the finger.

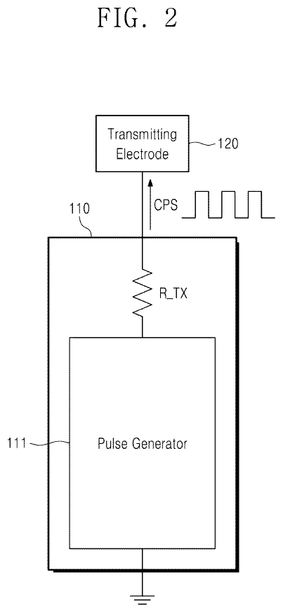

FIG. 2 is a diagram illustrating a signal transmitter according to an embodiment of the present disclosure.

Referring to FIG. 2, the signal transmitter 110 may include a pulse generator 111 and a transmitting resistor R_TX.

The pulse generator 111 may generate a sequence of pulse signals CPS to determine whether the target object 1 corresponds to a fake fingerprint. The sequence of pulse signals CPS may be in the form of continuous pulse waves and may pass through the transmitting resistor R_TX to be delivered to the transmitting electrode 120.

The pulse generator 111 may generate the sequence of pulse signals CPS in response to a pulse generation signal. For example, the sequence of pulse signals CPS may include M pulse signals. Each of the M pulse signals may have a different pulse width and pulse interval. The pulse generation signal may be generated by the signal processor 131 when the target object 1 makes contact with both the transmitting electrode 120 and the receiving electrode 140.

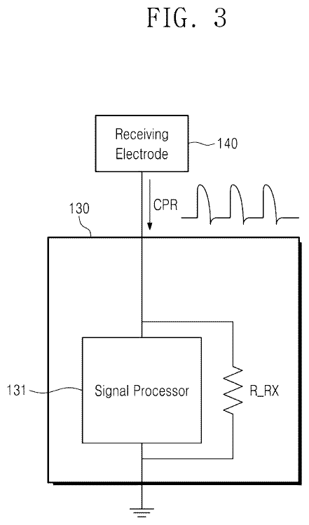

FIG. 3 is a diagram illustrating a signal receiver according to an embodiment of the present disclosure.

Referring to FIG. 3, the signal receiver 130 may include a signal processor 131 and a receiving resistor R_RX.

The receiving resistor R_RX corresponds to a load resistor of the signal receiver 130. The electrical characteristics of the target object 1 may act as a high-frequency filter depending on the finger capacitance C_F and the receiving resistor R_RX. In this case, the cutoff frequency f_{cf} caused by the target object 1 may be expressed by Equation 1.

$${f}_{cf} = \frac{1}{2 π \times R\_RX \times C\_F} \qquad [ Equation 1 ]$$

f_{cf} is the cut-off frequency caused by the target object 1. R_RX is the receiving equivalent resistance of the signal receiver. C_F is the finger equivalent capacitance of the target object 1.

The electrical characteristics of a live fingerprint may be utilized to determine whether the target object 1 corresponds to a live fingerprint or a fake fingerprint fabricated from materials such as silicone, rubber, film, gelatin, or synthetic resin.

The signal processor 131 may receive a sequence of pulse responses CPR through the receiving electrode 140. The sequence of pulse responses CPR corresponds to signals input to the receiving electrode 140 after the sequence of pulse signals CPS passes through the electrical channel of the target object 1. The sequence of pulse responses CPR may include M pulse responses respectively corresponding to the M pulse signals.

The signal processor 131 may perform a delay-time vector transformation for each of the M pulse responses. The delay-time vector transformation refers to a process of generating a delay-time vector whose elements are delay times at which a pulse response reaches predetermined voltage thresholds. The signal processor 131 may check N delay times for N predetermined voltage thresholds. The signal processor 131 may generate M delay-time vectors, each having N delay-time elements corresponding to each of the M pulse responses.

The signal processor 131 may generate a detection metric including the M delay-time vectors. The detection metric may be configured as an M×N matrix. Each row of the detection metric may correspond to one of the delay-time vectors, and each column may correspond to a delay time associated with a voltage threshold.

The signal processor 131 may determine whether the target object 1 corresponds to a fake fingerprint based on the detection metric. For example, the signal processor 131 may determine whether the target object 1 is a fake fingerprint based on boundaries formed by the delay times included in the detection metric. Alternatively, the signal processor 131 may determine whether the target object 1 corresponds to a fake fingerprint based on the detection metric and a pre-trained machine learning model.

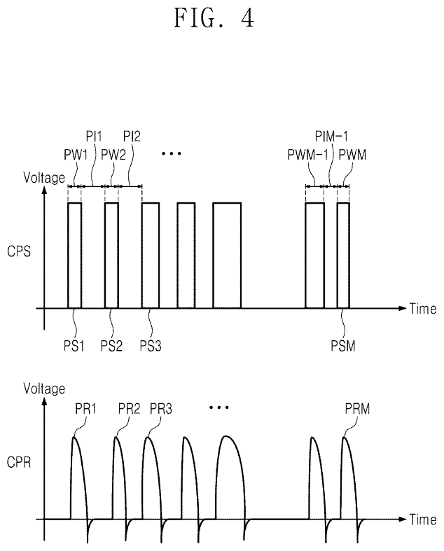

FIG. 4 is a diagram illustrating a sequence of pulse signals and corresponding pulse responses according to an embodiment of the present disclosure.

Referring to FIG. 4, the sequence of pulse signals CPS may include M pulse signals PS1, PS2, PS3, . . . , PSM. The sequence of pulse responses CPR may include M pulse responses PR1, PR2, PR3, . . . , PRM.

The pulse width of the pulse signal PS1 is PW1, and the pulse width of the pulse signal PS2 is PW2. The pulse interval between PS1 and PS2 is PI1, and the pulse interval between PS2 and PS3 is PI2. In this case, the pulse width PW1 and the pulse width PW2 may be different. The pulse interval PI1 and the pulse interval PI2 may also be different. The pulse widths of the M pulse signals PS1 to PSM and the pulse intervals PI1, PI2, . . . , PIM−1 between them may each be different from one another.

In one example, the pulse width and pulse interval of each of the M pulse signals PS1 to PSM may be increased for each pulse signal. In another example, the pulse width and pulse interval may be decreased for each pulse signal. The pulse width and pulse interval may alternatively be determined randomly.

Each of the M pulse responses PR1, PR2, PR3, . . . , PRM may correspond to one of the M pulse signals PS1, PS2, PS3, . . . , PSM. For example, the pulse response PR1 corresponds to the pulse signal PS1, and the pulse response PR2 corresponds to the pulse signal PS2. Likewise, the pulse response PRM corresponds to the pulse signal PSM. Since the external target object 1 and the load resistor R_RX of the signal receiver 130 act as a high-frequency filter, each of the M pulse responses PR1 to PRM may reflect electrical characteristics of the target object 1.

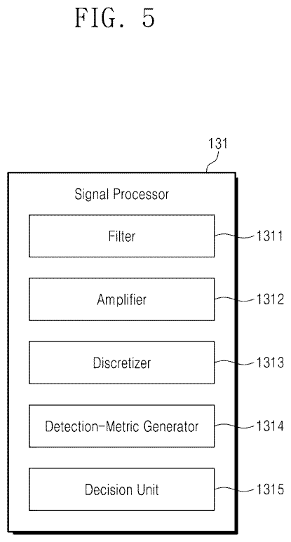

FIG. 5 is a diagram illustrating a signal processor according to an embodiment of the present disclosure.

Referring to FIG. 5, the signal processor 131 may include a filter 1311, an amplifier 1312, a discretizer 1313, a detection-metric generator 1314, and a decision unit 1315.

The filter 1311 may remove noise included in the signal received by the signal processor 131.

The amplifier 1312 may amplify an output of the filter 1311 to an appropriate level.

The discretizer 1313 may convert sampled voltages into discrete signals by using an analog-to-digital converter (ADC) or a comparator.

The detection-metric generator 1314 may generate delay-time vectors respectively corresponding to the sequence of pulse responses CPR and may generate a detection metric based on the delay-time vectors. The detection metric may be expressed as a matrix including the delay-time vectors. Each element of the detection metric may represent a delay time reflecting characteristics of the electrical channel of the target object 1.

The decision unit 1315 may generate a determination result indicating whether the target object 1 corresponds to a fake fingerprint based on the detection metric. The decision unit 1315 may determine whether the target object 1 is a fake fingerprint based on a boundary value derived from a boundary between a detection metric corresponding to a live fingerprint and a detection metric corresponding to a fake fingerprint.

The decision unit 1315 may also determine whether the target object 1 corresponds to a fake fingerprint by inputting the detection metric into a pre-trained machine learning model. The machine learning model may be a model trained using detection metrics labeled as either live fingerprints or fake fingerprints. The machine learning model may include at least one of a K-nearest neighbor (KNN) model, a support vector machine (SVM), a multi-layer perceptron (MLP), a convolutional neural network (CNN), a long short-term memory (LSTM) network, and a recurrent neural network (RNN).

The detection metric may be flattened into a one-dimensional vector before being input into the machine learning model. The one-dimensional detection metric may then be provided to the pre-trained machine learning model. The machine learning model may determine whether the target object 1 corresponds to a fake fingerprint based on the input detection metric.

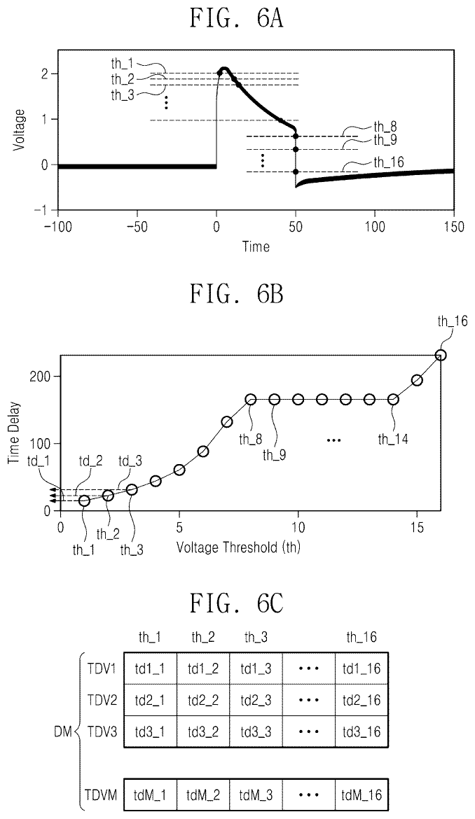

FIGS. 6A to 6C are diagrams illustrating the generation of a delay-time vector for a single pulse response according to an embodiment of the present disclosure.

Referring to FIG. 6A, a pulse response may be compared with multiple voltage thresholds. For example, the multiple voltage thresholds may include sixteen voltage thresholds. In this case, it is assumed that the pulse response is compared with first to sixteenth voltage thresholds th_1, th_2, . . . , th_16.

Referring to FIG. 6B, the signal processor 131 may determine a delay time td_1 at which the received pulse response reaches the first voltage threshold. The signal processor 131 may determine a delay time td_2 at which the received pulse response reaches the second voltage threshold. The signal processor 131 may determine delay times at which the pulse response reaches other voltage thresholds. When the pulse response reaches the same voltage threshold more than once, the delay time may be determined based on the most recent time at which the threshold is reached. The delay-time vector may include, as elements, the delay times at which the pulse response reaches each of the multiple voltage thresholds.

Referring to FIG. 6C, the signal processor 131 may generate a detection metric DM. The detection metric DM may include multiple delay-time vectors TDV1, TDV2, . . . , TDVM. Each delay-time vector TDV1 to TDVM may include delay times corresponding to specific voltage thresholds.

For example, the number N of the multiple voltage thresholds may be sixteen. In this case, the delay-time vector TDV1 corresponds to the first pulse response among the sequence of pulse responses. The first element of TDV1 may include a delay time td1_1 at which the first pulse response reaches the first voltage threshold th_1. The second element of TDV1 may include a delay time td1_2 at which the first pulse response reaches the second voltage threshold th_2. The sixteenth element of TDV1 may include a delay time td1_16 at which the first pulse response reaches the sixteenth voltage threshold th_16.

The delay-time vector TDV2 corresponds to the second pulse response. A delay time td2_1 included in TDV2 may indicate the time at which the second pulse response reaches the first voltage threshold th_1, and a delay time td2_2 included in TDV2 may indicate the time at which the second pulse response reaches the second voltage threshold th_2. Likewise, the delay-time vector TDVM may include delay times tdM_1 to tdM_16 corresponding to the times at which the M-th pulse response reaches the first to sixteenth voltage thresholds th_1 to th_16.

The detection metric DM may be a matrix defined by the delay times corresponding to the sequence of pulse responses and the multiple voltage thresholds. The detection metric DM may be used to determine whether the target object 1 corresponds to a fake fingerprint based on characteristics of the delay times.

Each element of the detection metric DM may initially have a value of zero. As the signal processor 131 receives the sequence of pulse responses, it may write the delay time corresponding to each voltage threshold in the appropriate position of the matrix. If a pulse response never reaches a particular voltage threshold, the element corresponding to that threshold in the matrix may remain zero.

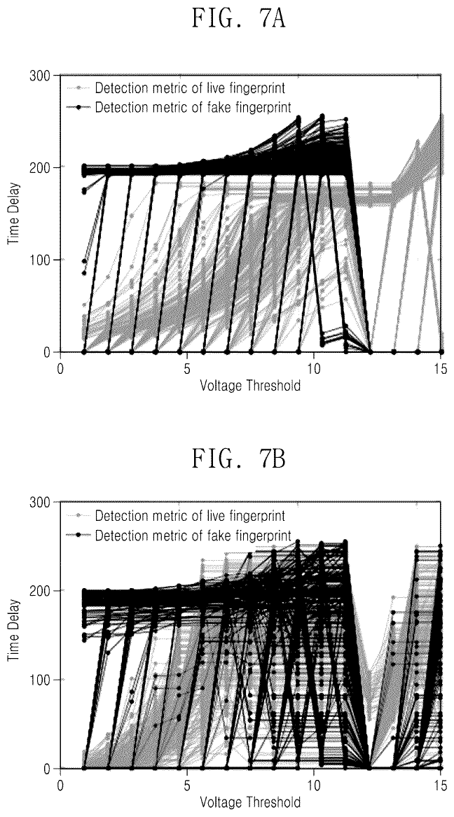

FIGS. 7A and 7B are exemplary diagrams illustrating detection metrics according to an embodiment of the present disclosure.

Referring to FIG. 7A, distributions of detection metrics for a live fingerprint and a fake fingerprint may be observed.

For example, it may be assumed that the multiple voltage thresholds include sixteen voltage thresholds. In this case, voltage values of the first to sixteenth voltage thresholds th_1 to th_16 may be set to 1.9 V, 1.75 V, 1.6 V, 1.4 V, 1.25 V, 1.1 V, 0.95 V, 0.8 V, 0.6 V, 0.45 V, 0.3 V, 0.15 V, −0.5 V, −0.4 V, −0.25 V, and −0.15 V, respectively.

The number of voltage thresholds and their respective voltage values are not limited thereto and may be determined to appropriate levels for determining whether a given object corresponds to a fake fingerprint.

The signal processor 131 may determine whether the target object 1 corresponds to a fake fingerprint based on a boundary between a detection metric of a fake fingerprint and a detection metric of a live fingerprint. For example, a detection metric generated from a fake fingerprint may include delay times that are greater than those of a live fingerprint detection metric at each voltage threshold. When delay times included in the detection metric exceed a predetermined boundary, the signal processor 131 may determine that the target object corresponds to a fake fingerprint. When the delay times included in the detection metric are smaller than the predetermined boundary, the signal processor 131 may determine that the target object 1 does not correspond to a fake fingerprint—i.e., that the target object 1 is a live fingerprint.

Referring to FIG. 7B, when electrical noise applied to the user's body or measurement errors are present, determining whether the target object corresponds to a fake fingerprint solely based on boundaries of the delay times in the detection metric may be limited.

In such a case, the signal processor 131 may determine whether the target object 1 corresponds to a fake fingerprint by using a pre-trained machine learning model. The machine learning model may be trained using detection metrics labeled as either live fingerprints or fake fingerprints.

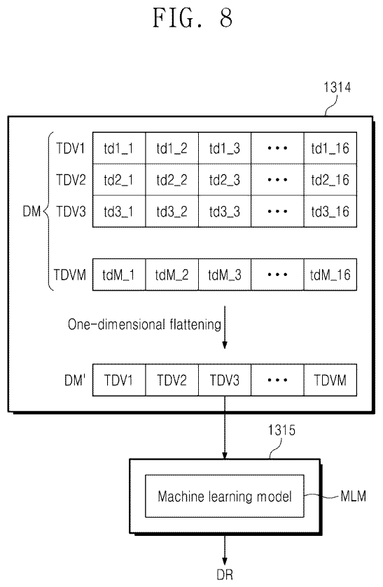

FIG. 8 is a diagram for explaining an input to a decision unit according to an embodiment of the present disclosure.

Referring to FIG. 8, the decision unit 1315 may include a machine learning model MLM. The machine learning model MLM may be trained using multiple detection metrics labeled as either live fingerprints or fake fingerprints. The machine learning model MLM may include at least one of a K-nearest neighbor (KNN) model, a support vector machine (SVM), a multi-layer perceptron (MLP), a convolutional neural network (CNN), a long short-term memory (LSTM) network, and a recurrent neural network (RNN).

KNN is a distance-based classification algorithm that determines whether the input corresponds to a fake fingerprint based on the K closest neighbors during classification.

SVM is a supervised learning algorithm that identifies a hyperplane for data classification and may classify the input as a live fingerprint or a fake fingerprint by selecting a hyperplane that maximizes a margin.

MLP is an artificial neural network having multiple layers of fully connected neurons.

CNN is an artificial neural network that extracts features using convolution operations.

RNN is a neural network that learns temporal dependencies of sequence data through a recurrent structure.

LSTM is a type of RNN that may be applied to the detection metric as time-series data and operates based on a cell state and gate mechanisms.

Meanwhile, the detection-metric generator 1314 may flatten the detection metric—an M×N matrix including delay times corresponding to N voltage thresholds for each of the M pulse responses-into a one-dimensional form. The flattening of the detection metric may be performed to provide an appropriate input format for KNN or SVM. For example, multiple delay-time vectors TDV1 to TDVM forming the rows of the matrix may be rearranged into a single column.

The flattened detection metric DM′ may be provided to the decision unit 1315. The machine learning model MLM included in the decision unit 1315 may receive the flattened detection metric DM′ and may generate a determination result DR based on pre-trained data. The determination result DR may indicate whether the target object corresponds to a fake fingerprint.

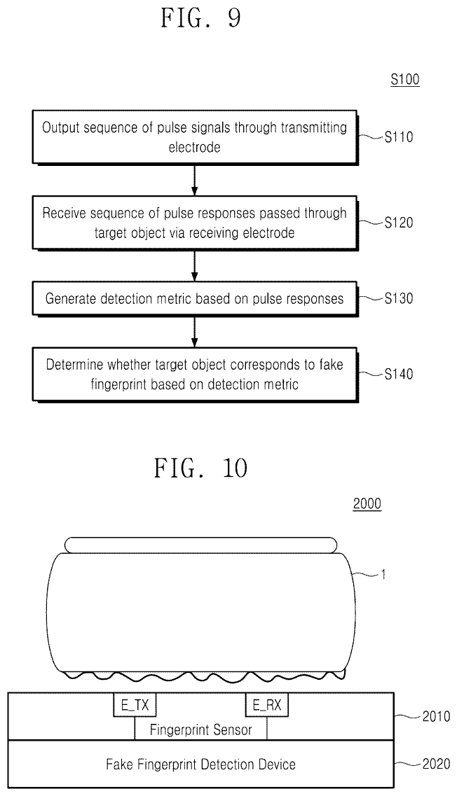

FIG. 9 is a flowchart illustrating an operating method of a fake fingerprint detection device according to an embodiment of the present disclosure.

Referring to FIG. 9, the operating method S100 of the fake fingerprint detection device may include outputting a sequence of pulse signals through a transmitting electrode in step S110. In this case, the sequence of pulse signals may have different pulse widths and different pulse intervals.

The operating method S100 may include receiving, via a receiving electrode, a sequence of pulse responses that have passed through a target object in step S120.

The operating method S100 may include generating a detection metric based on the sequence of pulse responses in step S130.

The detection metric may include delay-time vectors respectively corresponding to the sequence of pulse responses. Each delay-time vector may include delay times at which the pulse response reaches multiple voltage thresholds. When a pulse response reaches a first voltage threshold multiple times, the delay-time vector may include the delay time corresponding to the latest arrival time point.

The operating method S100 may include determining whether the target object corresponds to a fake fingerprint based on the detection metric in step S140.

Step S140 may further include inputting the detection metric into a pre-trained machine learning model and outputting a detection result from the machine learning model. The machine learning model may be trained using detection metrics labeled as either live fingerprints or fake fingerprints. The machine learning model may include any one of KNN, SVM, MLP, CNN, LSTM, or RNN.

In this case, step S130 may further include flattening the detection metric-configured as a matrix including multiple delay-time vectors-into a one-dimensional form. The flattening of the detection metric may be performed to provide input data suitable for KNN or SVM included in the machine learning model MLM. In step S140, the flattened detection metric may be input to the pre-trained machine learning model.

Step S120 may further include removing noise from the received sequence of pulse responses, amplifying the magnitude of the signals, and discretizing the signals.

FIG. 10 is a block diagram illustrating a fingerprint authentication system according to an embodiment of the present disclosure.

Referring to FIG. 10, a fingerprint authentication system 2000 according to an embodiment of the present disclosure may include a fingerprint sensor 2010 and a fake fingerprint detection device 2020.

The fingerprint sensor 2010 may capture a fingerprint image of a contacted target object 1 and may extract minutiae from the captured fingerprint image. The fingerprint sensor 2010 may compare the extracted minutiae with pre-registered minutiae of a user's fingerprint. The fingerprint sensor 2010 may perform user authentication based on the comparison result.

The fake fingerprint detection device 2020 may correspond to the fake fingerprint detection device 100 illustrated in FIG. 1. A transmitting electrode E_TX and a receiving electrode E_RX of the fake fingerprint detection device 2020 may be located on a surface of the fingerprint sensor 2010. A transmitting electrode E_TX may correspond to the transmitting electrode 120. A receiving electrode E_RX may correspond to the receiving electrode 140. The fake fingerprint detection device 2020 may output a sequence of pulse signals through the transmitting electrode E_TX and may receive a sequence of distorted pulse responses through the receiving electrode E_RX after the signals pass through the target object 1. The fake fingerprint detection device 2020 may generate a detection metric based on the sequence of pulse responses and may determine whether the target object 1 corresponds to a fake fingerprint based on the detection metric.

The fingerprint sensor 2010 may capture a fingerprint image of the target object 1 and extract minutiae in response to the fake fingerprint detection device 2020 determining that the target object 1 does not correspond to a fake fingerprint—that is, that the target object corresponds to a live fingerprint. The fingerprint sensor 2010 may compare the extracted minutiae with stored minutiae of a user's fingerprint and may perform user authentication.

Meanwhile, a fake fingerprint fabricated from materials such as silicone, rubber, film, gelatin, or synthetic resin may also bear fingerprint patterns of a user. Accordingly, an image captured by the fingerprint sensor 2010 from such a target object 1 may also include minutiae. Thus, without additional detection, there may be a possibility that user authentication is performed using the fake fingerprint.

The fingerprint authentication system 2000 according to an embodiment of the present disclosure may determine, through the fake fingerprint detection device 2020, whether the target object 1 corresponds to a live fingerprint or a fake fingerprint fabricated from other materials. When it is determined that the target object 1 corresponds to a fake fingerprint, the fingerprint authentication system 2000 may refrain from performing user authentication, thereby preventing authentication based on a forged fingerprint.

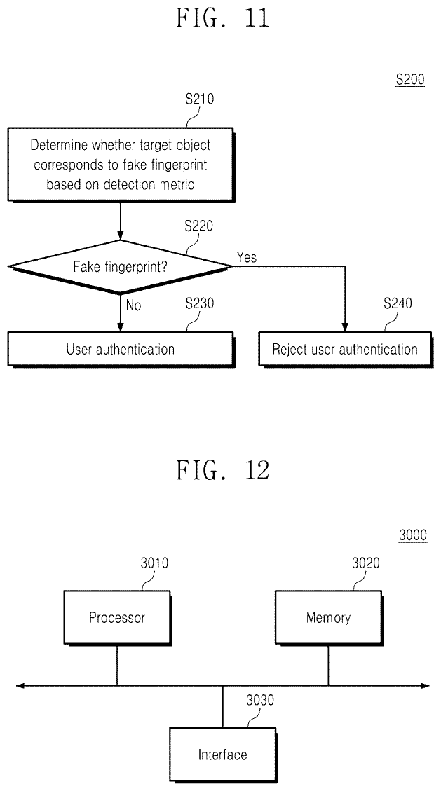

FIG. 11 is a flowchart illustrating a fingerprint authentication method according to an embodiment of the present disclosure.

Referring to FIG. 11, the fingerprint authentication method S200 may include determining whether a target object corresponds to a fake fingerprint based on a detection metric in step S210. Step S210 may be performed by the fake fingerprint detection device 2020. Step S210 may correspond to step S140 of the operating method S100 of the fake fingerprint detection device 100.

The fingerprint authentication method S200 may include performing user authentication in step S230 when it is determined in step S220 that the target object corresponds to a live fingerprint (S220—No). Step S230 may be performed by the fingerprint sensor 2010. In step S230, the fingerprint sensor 2010 may capture a fingerprint image of the target object 1, extract minutiae from the fingerprint image, and determine whether the target object 1 corresponds to the user's fingerprint by comparing the extracted minutiae with pre-stored user minutiae.

The fingerprint authentication method S200 may include rejecting user authentication in step S230 when it is determined in step S220 that the target object corresponds to a fake fingerprint (S220—Yes). In step S230, the fingerprint image of the target object 1 may not be captured.

FIG. 12 is a diagram illustrating an example of a computing system that constitutes a signal processor according to an embodiment of the present disclosure.

Referring to FIG. 12, a computing system 3000 may include a processor 3010, a memory 3020, and an interface 3030.

The processor 3010 may control various operations including data processing of the signal processor 131. The processor 3010 may execute firmware or software loaded in the memory 3020. The processor 3010 may include at least one general-purpose processor, such as a central processing unit (CPU) or an application processor (AP). The processor 3010 may also include at least one special-purpose processor, such as a neural processing unit (NPU), a neuromorphic processor, or a graphics processing unit (GPU). The processor 3010 may include two or more processors of the same type.

The memory 3020 may store codes and instructions executed by the processor 3010 and may store data processed by the processor 3010. For example, the memory 3020 may store data related to received response signals, delay-time vectors generated based on the response signals, detection metrics generated based on the delay-time vectors, and determination results generated based on the detection metrics. The memory 3020 may include volatile memory such as RAM (Random Access Memory) or SRAM (Static Random Access Memory), or non-volatile memory such as a flash memory type, a hard disk type, a multimedia card micro type, a card-type memory (e.g., SD or XD memory), ROM (Read-Only Memory), EEPROM (Electrically Erasable Programmable ROM), or PROM (Programmable ROM).

The interface 3030 may provide signal or data communication between the computing system 3000 and an external device. For example, the processor 3010 may determine whether the target object is in contact with the transmitting and receiving electrodes based on changes in the levels of the electrodes. When the target object is in contact with both the transmitting and receiving electrodes, the processor 3010 may output a pulse generation signal through the interface 3030. The pulse generation signal may be delivered to the pulse generator 111.

The interface 3030 may receive a sequence of pulse responses transmitted from the receiving electrode. Data related to the sequence of pulse responses may be stored in the memory 3020.

Meanwhile, the processor 3010 and the interface 3030 may provide a determination result related to a fake fingerprint to an external device. The interface 3030 may deliver the determination result to the fingerprint sensor, and the fingerprint sensor may perform or reject user authentication based on the determination result.

The fake fingerprint detection device, the operating method thereof, and the fingerprint authentication system according to embodiments of the present disclosure may use the delay times corresponding to voltage thresholds for each of the pulse responses as features for determining whether a fingerprint is fake. Accordingly, fake fingerprints such as spoofed fingerprints may be accurately detected, thereby enhancing user security.

The foregoing description illustrates specific embodiments for implementing the present disclosure. The present disclosure is not limited to the embodiments described above, and various modifications or alterations that may be easily made by those skilled in the art are also encompassed by the present disclosure. Further, technologies that may be easily modified or implemented using the embodiments are also included within the scope of the present disclosure. Therefore, the scope of the present disclosure should not be limited by the above-described embodiments but should be defined by the claims and equivalents thereof.

What is claimed is:

1. A fake fingerprint detection device comprising:
a transmitting electrode and a receiving electrode configured to contact an external target object;
a signal transmitter configured to output a sequence of pulse signals through the transmitting electrode; and
a signal receiver configured to receive a sequence of pulse responses that have passed through the target object through the receiving electrode,
wherein the signal receiver comprises a signal processor configured to generate a detection metric based on the sequence of pulse responses and determine, based on the detection metric, whether the target object corresponds to a fake fingerprint.

2. The fake fingerprint detection device of claim 1, wherein the signal processor comprises:
a detection-metric generator configured to generate delay-time vectors respectively corresponding to the sequence of pulse responses and generate the detection metric based on the delay-time vectors; and
a decision unit configured to generate a determination result indicating whether the target object corresponds to a fake fingerprint based on the detection metric.

3. The fake fingerprint detection device of claim 2, wherein each of the delay-time vectors comprises delay times at which the corresponding pulse response reaches predetermined voltage thresholds.

4. The fake fingerprint detection device of claim 3, wherein, when the corresponding pulse response reaches a first voltage threshold multiple times, the delay time is determined based on a latest arrival time point.

5. The fake fingerprint detection device of claim 2, wherein the decision unit comprises a machine learning model trained using detection metrics labeled as either live fingerprints or fake fingerprints.

6. The fake fingerprint detection device of claim 5, wherein the machine learning model comprises any one of a K-nearest neighbor (KNN) model, a support vector machine (SVM), a multi-layer perceptron (MLP), a convolutional neural network (CNN), a long short-term memory (LSTM) network, and a recurrent neural network (RNN).

7. The fake fingerprint detection device of claim 5, wherein the detection-metric generator is configured to output a detection metric flattened into a one-dimensional form.

8. The fake fingerprint detection device of claim 1, wherein each of the pulse signals of the sequence of pulse signals has a different pulse interval and a different pulse width.

9. The fake fingerprint detection device of claim 1, wherein the signal processor further comprises:
a filter configured to remove noise from received signals;
an amplifier configured to amplify the received signals; and
a discretizer configured to discretize the received signals.

10. An operating method of a fake fingerprint detection device, the operating method comprising:
outputting a sequence of pulse signals through a transmitting electrode;
receiving, through a receiving electrode, a sequence of pulse responses that have passed through a target object;
generating a detection metric based on the sequence of pulse responses; and
determining, based on the detection metric, whether the target object corresponds to a fake fingerprint.

11. The operating method of claim 10,
wherein generating the detection metric comprises:
generating delay-time vectors respectively corresponding to the sequence of pulse responses; and
combining the delay-time vectors, and
wherein determining whether the target object corresponds to a fake fingerprint comprises generating a determination result indicating whether the target object corresponds to a fake fingerprint based on the detection metric.

12. The method of claim 11, wherein each of the delay-time vectors comprises delay times at which the corresponding pulse response reaches predetermined voltage thresholds.

13. The method of claim 12, wherein, when the corresponding pulse response reaches a first voltage threshold multiple times, the delay time is determined based on a latest arrival time point.

14. The method of claim 11, wherein generating the determination result comprises inputting the detection metric into a machine learning model trained using detection metrics labeled as either live fingerprints or fake fingerprints.

15. The method of claim 14, wherein the machine learning model comprises any one of a K-nearest neighbor (KNN) model, a support vector machine (SVM), a multi-layer perceptron (MLP), a convolutional neural network (CNN), a long short-term memory (LSTM) network, and a recurrent neural network (RNN).

16. The method of claim 14, wherein generating the detection metric comprises flattening the detection metric into a one-dimensional form.

17. The method of claim 10, wherein each of the pulse signals of the sequence of pulse signals has a different pulse interval and a different pulse width.

18. The method of claim 10, wherein receiving the sequence of pulse responses comprises:
removing noise from the sequence of pulse responses;
amplifying the noise-removed pulse responses; and
discretizing the amplified pulse responses.

19. A fingerprint authentication system comprising:
a fake fingerprint detection device configured to output a sequence of pulse signals through a transmitting electrode, receive a sequence of pulse responses that have passed through a target object through a receiving electrode, generate a detection metric based on the sequence of pulse responses, and determine whether the target object corresponds to a fake fingerprint based on the detection metric; and
a fingerprint sensor configured to, in response to the target object being determined to correspond to a live fingerprint, capture a fingerprint image of the target object, extract minutiae from the fingerprint image, compare the extracted minutiae with pre-registered user minutiae, and perform user authentication based on the comparison.

20. The fingerprint authentication system of claim 19, wherein the transmitting electrode and the receiving electrode are located on a surface of the fingerprint sensor.
